(19) United States
(12) Patent Application Publication
(10) Pub. No.: US 2016/0350844 A1
(43) Pub. Date: Dec. 1, 2016

(54) SYSTEMS AND METHODS FOR ALLOCATION OF DYNAMICALLY RECEIVED DATA TRANSACTION REQUESTS BASED ON PRIOR PENDING DATA TRANSACTION REQUESTS

(71) Applicant: Nasdaq, Inc., New York, NY (US)

(72) Inventor: Greg FERRARI, New York, NY (US)

(21) Appl. No.: 15/170,081

(22) Filed: Jun. 1, 2016

Related U.S. Application Data
(60) Provisional application No. 62/169,265, filed on Jun. 1, 2015.

(51) Int. Cl. G06Q 30/08; G06Q 40/04

(52) U.S. Cl. CPC G06Q 30/08; G06Q 40/04

(57) ABSTRACT

A computer system includes a memory that stores two lists of electronic data transaction requests. The computer system receives an electronic data transaction request that includes an auction order. The computer system runs an automated auction process based on the auction order and receives auction response messages. The system determines if a participant displayed an order at the NBBO prior to initiation of the auction. If so, any auction response messages from that participant are prioritized, against other participants, when allocating the auction order occurs, on a price level basis.

### CROSS REFERENCE(S) TO RELATED APPLICATION(S)

This application claims the benefit of U.S. Provisional Application No. 62/169,265 filed Jun. 1, 2015, the entire contents of which are incorporated herein by reference.

### TECHNICAL OVERVIEW

The technology herein relates to allocating electronic order data messages during a dynamic matching process based on the presence of prior pending electronic order data messages.

### INTRODUCTION

There exist a number of electronic exchange platforms that enable trading of options contracts—Nasdaq BX Options, the Nasdaq Options Market, and Nasdaq PHLX are such example platforms.

One aspect of exchange platforms in general and which may be hidden from ordinary users is the different entities, modules, and systems that interface with each other in order to facilitate the electronic trading of financial instruments such as options contracts. Moreover, U.S. based electronic exchange platforms for options trading may be required to continuously disseminate its match or execution data to the National Best Bid Offer (“NBBO”) database, which is managed by the Options Price Reporting Agency (“OPRA”).

In addition to the above mentioned technical complexity there are a number of ways individuals and entities can access an automated electronic exchange platform. For example, a typical public-customer normally does not interact directly with a computerized electronic exchange platform, but rather interacts via a broker-dealer who in turn interacts with the exchange platform on behalf of the public-customer. A public-customer is a person that is not a registered broker-dealer or a dealer in securities. And, a professional is any person, or entity, that is not a broker-dealer but places more than a certain, predefined, number of orders in listed options, per day on average during a calendar month for its own beneficial account(s). A broker-dealer has privileges to buy and sell on behalf of public-customers, as well as on their own accounts. These privileges are however subject to rules set out by respective organizations that operate exchange platforms in their capacities as self-regulatory organizations (“SROs”) and rules from the U.S. Securities and Exchange Commission (“SEC”).

Certain professionals or broker-dealers that act on various exchange platforms are called Market Makers. This sub-set of entities has certain, additional privileges and responsibilities. A Market Maker for a certain market has the obligation to ‘make’ that market by always maintaining a bid to buy at a bid price and an offer to sell at an offer price. In return for ‘making’ the market a Market Maker typically receives some incentive such as receiving a marketing fee, or an enhanced allocation of its submitted and subsequently matched orders.

Most exchange platforms include rules on how trades between buyers and sellers are to be allocated under various conditions. For example, when a number of buyers all bid at the same price, the rules describe how the various buyers are allocated to the corresponding sellers. In the case of option contracts, the rules may determine how option contracts from each buyers will be allocated to the sellers if there is an insufficient number of corresponding sell contracts. The rules on how option contracts are allocated may also depend on what type of buyer is involved; e.g., public-customers may get partial or full allocation priority over broker-dealers.

### SUMMARY

In certain example embodiments, an electronic exchange computer system (exchange) is configured (e.g., programmed) to accept paired orders submitted from a client computer system. A paired order includes a first order (a PRISM order), and a second order (an Initiating Order) that is contra to the first order. The first order includes a “stop price” at which the participant associated with the submitting client computer system is guaranteed execution by the participant. The submitted order is marked by the client computer system as an order that will be processed using an auction improvement process by the electronic exchange computer system.

Upon reception and validation of a paired order that indicates that the auction improvement process is to be used, the auction process is started by the exchange. During the time period of the auction process, other client computer systems may submit response electronic data messages seeking to match against the submitted PRISM order. Once the auction time period expires, the responses received by the exchange during the auction are processed to determine what submitted orders will be matched against the PRISM order. Client systems that are classified as Market Makers by the exchange and that also had displayed orders at the NBBO at the time the auction was initiated will have allocation priority over other Market Makers who were not on the NBBO at the time of initialization of the auction.

In certain example embodiments, the paired order may specify a “No-Worse-Than” (NWT) price that allows the contra-order (the initiating order) to match other interest to a specified price level. In certain examples, the stop price and the NWT price are not cancelable, but may be improved.

In certain examples, the Initiating Order is guaranteed a certain percentage (after all customer interest has been satisfied). The percentage may vary based on whether there is one or multiple orders that match with the PRISM order at the execution price. For example, the percentage may be 40% if there are multiple orders that match at the execution price, and 50% if it only one other order is matched at the execution price.

In certain example embodiments, an electronic exchange computer system (referred to as an exchange herein) is provided. The exchange includes a memory that stores a first and second list of electronic data order messages each associated with a symbol identifier, the first and second list, respectively, having a first plurality of electronic data order messages and a second plurality of electronic data order messages with each of the first and second plurality of electronic data order messages having at least a size value, a price value and being associated with a corresponding participant identifier and the symbol identifier.

The example exchange includes a transceiver configured to receive electronic data order messages from other computing devices, the electronic data order messages including data messages that correspond, respectively, to each of the electronic order data messages of the first and second plurality. The exchange includes a programmed processing system that includes at least one hardware processor coupled to the memory and the transceiver.

The processing system is programmed (e.g., configured) to obtain or otherwise track a national best bid or offer (NBBO) for the symbol identifier. Receive, via the transceiver, a first electronic order data message that includes at least 1) a request to initiate an automated auction process for an auction order, 2) a first price value for the auction order, and 3) a first quantity value for the auction order, the auction order being contra to the first plurality of electronic data order messages and associated with an identifier of a participant who submitted the auction order. Start the automated auction process for a predetermined period of time based on reception of the first electronic order data message and determination of the request included therein. Generate and then transmit, using the transceiver, auction notification messages to at least some of the other computing devices. During the predetermined period of time, receive at least first and second electronic auction response messages that each include a corresponding price value and size value and that are associated with a corresponding participant identifier. In response to expiration of the predetermined period of time, end the auction process. Determine whether any of the first and second electronic auction response messages are associated with a first participant identifier that is also associated with one of the first plurality of electronic data order messages that is determined to be at the NBBO at the time the auction process was initiated. As a result of determining that the first participant identifier is also associated with one of the first plurality of electronic data order messages that is at the NBBO, prioritize allocation of the auction order to a corresponding electronic auction response message that is associated with the first participant identifier.

The features described herein may be combined to form additional embodiments and sub-elements of certain embodiments may form yet further embodiments. This summary is provided to introduce a selection of concepts that are further described below in the detailed description. This summary is intended neither to identify key features or essential features of the claimed subject matter, nor to be used to limit the scope of the claimed subject matter; rather, this summary is intended to provide an overview of the subject matter described in this document. Accordingly, it will be appreciated that the above-described features are merely examples, and that other features, aspects, and advantages of the subject matter described herein will become apparent from the following detailed description, figures, and claims.

### BRIEF DESCRIPTION OF THE DRAWINGS

These and other features and advantages will be better and more completely understood by referring to the following detailed description of example non-limiting illustrative embodiments in conjunction with the drawings of which:

FIG. 1 shows illustrates a non-limiting example function block diagram of a computer-implemented exchange system;

FIG. 2 is a non-limiting block diagram of an example exchange platform shown in FIG. 1; and

FIGS. 3-6 are a signaling diagrams showing the performance of a process using the components of FIGS. 1 and 2 according to certain example embodiments.

### DETAILED DESCRIPTION

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail. Individual function or process blocks are shown in the figures. Those skilled in the art will appreciate that the functions of those blocks may be implemented using individual hardware circuits, using software programs and data in conjunction with a suitably programmed hardware, using applications specific integrated circuitry (ASIC), and/or using one or more digital signal processors (DSPs). The software program instructions and data may be stored on non-transitory computer-readable storage medium and when the instructions are executed by a computer, or other suitable hardware processor, control the computer or hardware processor to perform the functions.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred. A description of a process is a description of an apparatus for performing the process. The apparatus that performs the process may include, e.g., a processor and those input devices and output devices that are appropriate to perform the process.

Various forms of non-transitory, computer-readable media may be involved in carrying data (e.g., sequences of instructions) to a processor. For example, data may be (i) delivered from RAM to a processor; (ii) or instructions for a process may be stored in an instruction register and loaded by a processor. Instructions and/or data may be carried over other types of transmission medium (e.g., wire, wireless, optical, etc.) and/or transmitted according to numerous formats, standards or protocols, such as Ethernet (or IEEE 802.3), SAP, ATP, Bluetooth, and TCP/IP, TDMA, CDMA, 3G, etc.; Such transitory signals may be coupled to non-transitory media (e.g., RAM, a receiver, etc. . . . ), thus transitory signals will be coupled to non-transitory media. The transitory and non-transitory signals, instructions, and/or data, may be encrypted to ensure privacy or prevent fraud in any of a variety of ways well known in the art.

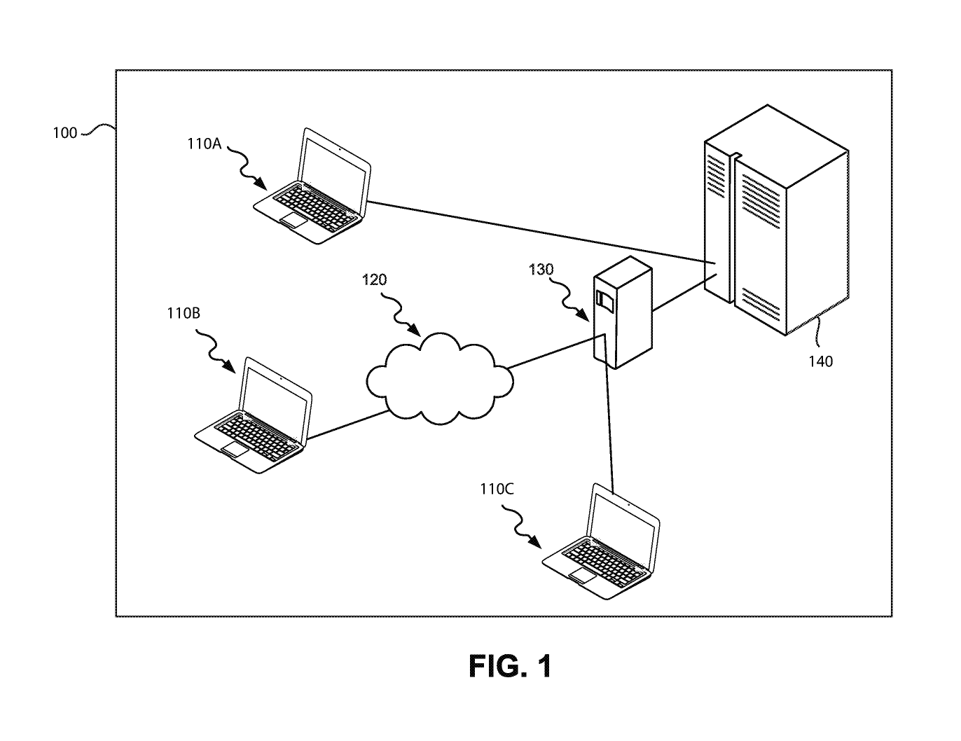

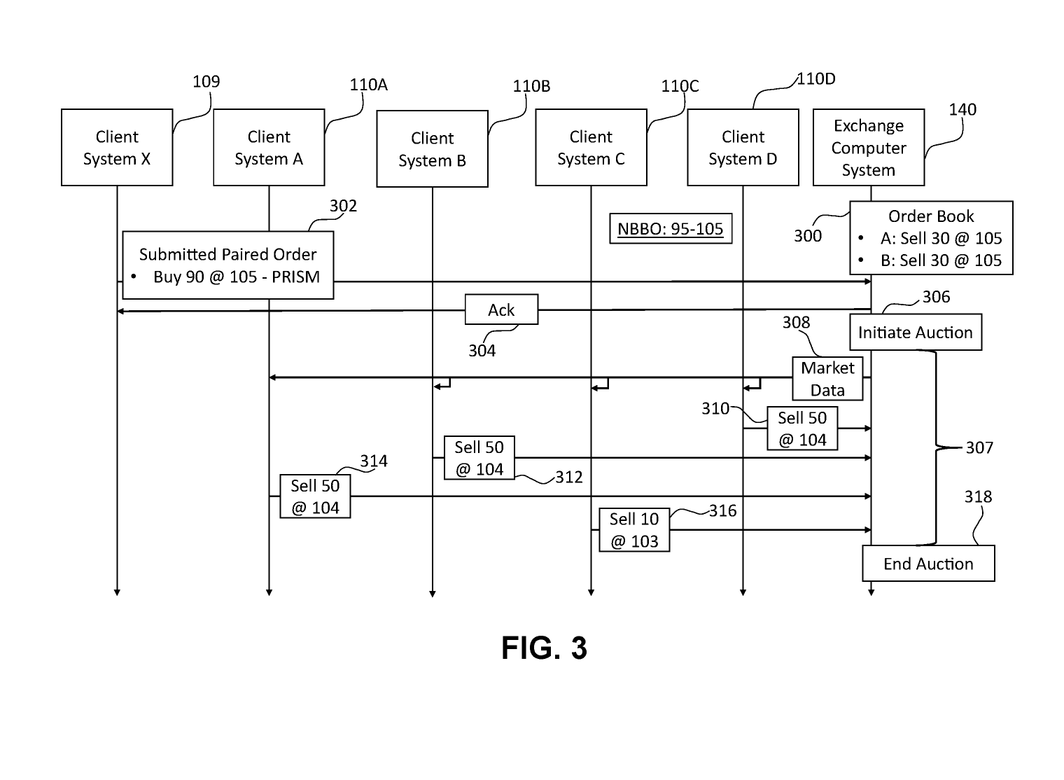

FIG. 1 illustrates an example automated exchange system 100 comprising trader terminals (sometimes referred to as client computer systems or client systems) 110 (110A, 110B, and 110C, along with client system X 109 and client system D 110D in FIG. 3) that are used for submitting electronic data order messages to an automated electronic exchange computer system (exchange) 140. The trader terminals 110 are connected to exchange 140 over a suitable network 120, which may include dedicated electronic data channels that may be used by participants of exchange 140. As used herein, participants refer to the person or other legal entity that controls the client computer systems and/or the person or entity that is associated with an electronically submitted data transaction request (e.g., an electronic order). In certain instances, an order may be associated with two or more participants. One participant may be the legal entity controlling the client computer system that directly communicates with exchange 140 (e.g., a broker). Another participant may be a member of the general public that has the broker or other entity submit the electronic order for them to the exchange 140 (e.g., that the broker acts as an agent for).

The network 120 may e.g., be the Internet, or another suitable data connection channels, such as a dedicated fiber connection. The exchange 140 can be hosted on a computer server, a series of servers or other suitable computing solution (e.g., a so-called cloud-based computing solution). Sometimes the trader terminals 110 are connected to the exchange 140 through an entry gateway 130 connected to, or being a part of, the exchange 140 and configured to receive electronic data messages that include data transaction requests. These requests may be, for example, requests to “buy,” “sell,” or take other market actions, i.e., orders and/or quotes from the trader terminals 110. An entry gateway 130 is usually in data communication with the exchange 140 on a dedicated network and forwards data contained in the electronic data messages (e.g., the orders contained therein) to the exchange 140 and further usually broadcast updates back to the trader terminals 110. It should be understood that information being communicated to and from the exchange 140 and the trader terminals 110 could be communicated via a single communication path (e.g., wired or wireless) or over several and disparate channels.

While the trading terminals 110 in FIG. 1 are illustrated as trading terminals that traditionally are associated with manual input of market actions, the trading terminals 110 can also be implemented as algorithmic trading units on a corresponding computer system, sometimes termed automatic order generators, having manual input means (e.g., a keyboard, mouse, or other devices to provide input to the software and/or hardware that is used to control the functionality associated with the algorithmic trading unit) for control of the algorithmic trading unit. The algorithmic trading unit is pre-programmed with instructions (e.g., a series of steps in a process) to automatically generate sell and buy orders and quotes (or changes/cancellations thereof) in response to input data received from the exchange 140. Generally, for the techniques described herein, no manual input is required for initiating a trade during the described electronic auction process. For example, exchange 140 may provide an electronic data feed to trading terminals 110 (e.g., via network 120). The electronic data feed may include electronic data messages generated based on the state of the exchange 140. Based on the reception of the messages that are part of the electronic data feed, the algorithmic trading unit may be programmed to generate a new electronic data message that includes a data transaction request. These newly generated electronic data messages may then be submitted to the exchange 140 for processing thereon. The trading terminals 110 may also represent (e.g., be controlled by) market makers inputting quotes to the exchange 140. Accordingly, the entire auction process (both for the process executed on the exchange 140 and the processed executed on the client systems) may be automated.

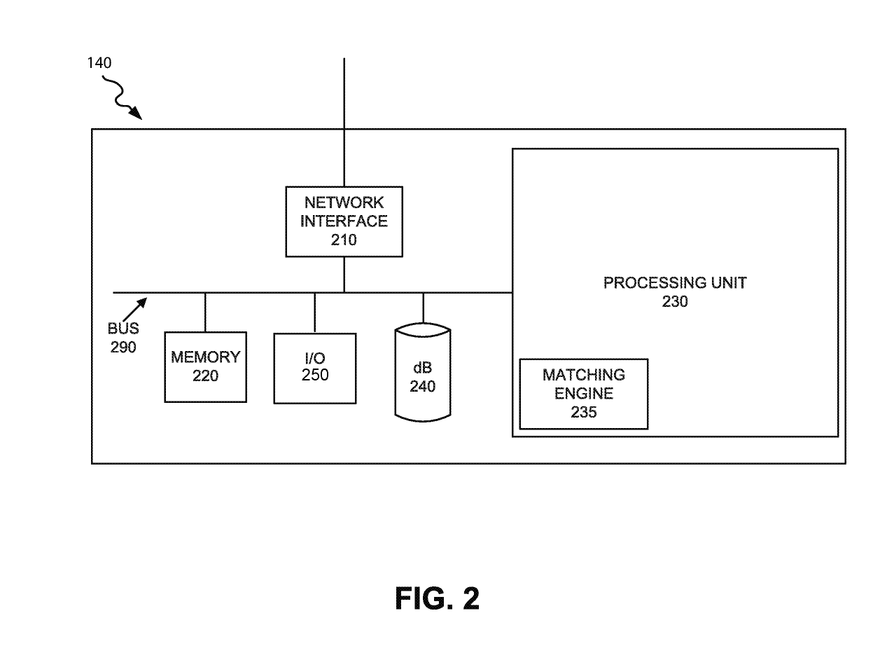

FIG. 2 illustrates a computer implemented, non-limiting, example embodiment of the exchange 140. This example embodiment comprises a network interface 210, a memory (typically a random access memory (RAM) or another non-volatile storage means) 220, a processing logic 230 including a matching module 235 (e.g., which may be software that is executed by hardware or a specifically designed hardware), a storage memory or other database (e.g. a hard drive) 240 and an input/output (I/O) controller 250 all coupled by an electronic data bus 290.

In some embodiments, the processing unit 230 may include, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors uses an instruction set architecture such as x86 or Advanced RISC Machine (ARM).

In some embodiments, each or any of the memory 220 and storage 240 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processing unit 230). Memory 220 is an example of non-transitory computer-readable storage media.

In certain example embodiments, memory 220 is arranged to store different data for the exchange 140. For example, the memory may store a dual sorted list of electronic data transaction requests. These lists may be sorted according to certain characteristics or parameters of the data transaction requests (e.g., based on time, a size associated with the data transaction requests, a price value, a combination thereof, etc. . . . ). In certain example embodiments, the memory 220 stores an order book comprising matchable sell orders (a first side), buy orders (a second side), and/or quotes, which have not been matched by the matching module 235. While only one processor 230 and one memory 220 are shown in FIG. 2, it is understood that the exchange 140 in some embodiments is configured with several processors and/or memories interconnected according to normal practices in the field of computer science, but for sake of clarity only one of each is shown.

In some example embodiments, the exchange 140 is implemented on a server-type computer and in yet further embodiments the exchange 140 is included in a cluster of such server-type computers. The storage memory 240 is adapted to store executable computer programs and various database information.

The exchange 140 is, through an external network interface 210, connectable to a network (e.g., 120 in FIG. 1), not illustrated in FIG. 2. The external network interface 210 is a device capable of sending/receiving traffic. The network comprises conventional network means, as well as front end applications. Examples of such front end applications are trading systems (not illustrated) and trading terminals 110 that are used by participants of the exchange 140 for submitting market actions (e.g., input or transmit electronic data messages comprising instructions to process new, altered, or cancelled orders and/or quotes) to the exchange 140.

In some embodiments, the network interface 210 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some example embodiments, the modules and interfaces comprise both hardware and software components (e.g., a series of steps or instructions that are carried out by the underlying hardware resources). Further, in some embodiments the matching engine 235 comprises a computer program, or part of a computer program stored at a memory 220 and/or database 240 and a processor 230 that access the computer program, such that the processor 230 performs the method(s) according to the embodiments described herein (e.g., in connection with FIGS. 3-6). Yet in further embodiments, the processor 230 is of standard type (e.g., one core per processor); and in yet further embodiments the processor is a multi-core processor.

In accordance with embodiments described herein, the matching engine 235 is configured as depicted in FIG. 2. The matching engine 235 is adapted to perform matching of quotes and orders received via the external interface 210. In certain embodiments, in addition to receiving orders and quotes via the external interface 210, the matching engine 235 is adapted to decode the received order message, which comprises data related to an owner of the order and other order specific parameters for the financial instrument.

FIG. 3 is a signaling diagram showing the performance of a process using the components of FIGS. 1 and 2 according to certain example embodiments.

Certain example embodiments disclosed herein allow client system X 109 and/or other client systems 110 (e.g., computer systems) to enter paired orders via electronic order data messages to exchange 140.

In the example shown in FIG. 3, the electronic order book for a given symbol being tracked by exchange 140 includes two orders that are pending in the order book that have been previously submitted by client systems A and B. In this example, the participants associated with client systems A and B are both market makers for this particular symbol. Orders from client A and client B (market marker A and market marker B) are orders to sell 30 at 105 and listed as quotes in the maintained order book.

A paired order may be submitted to the exchange 140 for a price improvement auction, or process. A paired order (described in greater detail below) is a two-sided order that includes a buy order and corresponding sell order. Order data messages that are of price-improvement-type may include one of more data fields (e.g. as shown in Tables 1 and/or 2 below), or a flag, to indicate that the order is to be processed with a price improvement process. Once a so-marked order is received by exchange 140, the order may be “stopped” upon receipt at a price, which is equal to or better than the NBBO.

In FIG. 3, client system 109 (e.g., controlled by a participant that is submitting a paired order that will use the price improve mechanism, or PRISM) may electronically submit, at step 302, an electronic order data message that includes a paired order data message. The electronic order data message includes an order that the participant of client system X 109 is representing as agent on behalf of a public customer, broker dealer, or any other entity. This is the first order of the paired orders being submitted and is termed the “PRISM Order” herein. The electronic order data message also include a contra-side principle or agency order. This second order in the paired order is termed an “Initiating Order” herein. In certain examples, the order size of the Initiating Order must equal the size of the PRISM order. The PRISM order may be submitted for electronic execution to the exchange 140 pursuant to below example embodiment(s).

In certain example embodiments, if either the PRISM order or the Initiating Order is for the account of a public customer, such customer order will be treated as the PRISM Order. If both the PRISM order and the Initiating Order are public customer orders, then the PRISM process will not be used and the orders will match without a price improvement process being performed.

As used herein, the above referenced “public customer” is a participant (e.g. a person or entity) that is not classified as a broker or dealer in securities. In certain example embodiments, orders that are from professionals are not public customer orders. In certain examples, an order from a professional includes any participant that a) is not a broker or dealer in securities, and 2) places more than a predefined number of orders (e.g., 390) in listed options per day on average during a calendar month for its own beneficial account(s). Accordingly, in certain examples, a participant may be classified as a professional by the exchange 140.

In certain example embodiments, all options or symbols (i.e., a symbol identifier) that are traded on the exchange 140 are eligible to use the price improvement mechanism. A Participant (the “Initiating Participant”), such as the participant controlling client system X, may cause the exchange 140 to initiate an auction process according to the example embodiments described herein, provided one or more, or all of the following are met:

First, if the PRISM Order is for the account of a Public Customer, the Initiating Participant must stop the entire PRISM Order at a price that is equal to or better than the National Best Bid/Offer displayed (“NBBO”) on the opposite side of the market from the PRISM Order, provided that such price must be at the minimum trading increment (e.g., 1 cent or 1 dollar, or other increment as defined on a per instrument or exchange basis) or better than any limit order on the limit order book on the same side of the market as the PRISM Order.

Second, if the PRISM Order is for the account of a broker dealer or any other person or entity that is not a Public Customer the Initiating Participant must stop the entire PRISM Order at a price that is the better of: (i) the local best bid or offer (BBO) of exchange 140 (sometimes also referred to as the BX BBO herein) price improved by at least the minimum increment on the same side of the market as the PRISM Order, or (ii) the PRISM Order's limit price (if the order is a limit order), provided in either case that such price is at or better than the displayed NBBO.

In certain example embodiments, if a submitted PRISM order does not comply with either of the above two requirements, then it is not eligible to initiate an auction and will be rejected by exchange 140.

Additionally, in certain example embodiments, a PRISM order submitted at or before the opening of trading is not eligible to initiate an auction and will be rejected by the exchange 140. In certain example embodiments, a PRISM order submitted during a final time period of a trading session (e.g., the final one, two, or five seconds) in the affected series is not eligible to initiate an auction and will be rejected by the exchange 140. In certain example embodiments, an Initiating Order of the submitted paired order may not be a solicited order for the account of any Market Maker assigned in the affected series. Any of this conditions may result in the PRISM order being rejected.

After reception of the submitted paired order in step 302 (and verification that the paired order is valid according to the above parameters), the exchange 140 may send a responsive acknowledgement message in step 304 to client system X 109 indicating that the order will be processed using a price improvement mechanism. Alternatively, if the order was not a compliant PRISM data transaction request, then the acknowledgement message in step 304 may be a message indicating that the order has not been entered with a corresponding explanation as to why (e.g., the price of the PRISM order was not at or better than the NBBO).

After reception of the order, the auction process is initiated at step 306. The order that is being processed by using the potential price improvement process is exposed to participants (e.g., client systems 109, 110A, 110B, 110C, and/or 110D) through an electronic data feed at step 308. In certain examples, the electronic data feed is generated and transmitted from exchange 140 (or a computer system associated therewith), as well as (or alternatively) via a specialized quote feed. The initiated auction process will occur over a predefined time period (e.g., 307) that may be 1 second, 500 milliseconds, 200 milliseconds, or the like. In certain example embodiments, exchange 140 maintains a timer to track when the auction expires. During the predefined time period for auction process, client systems 110 may submit price-improvement order messages (termed PAN responses herein). Such order messages may be at any price equal to, or better, than the “stopped” price (in the example in FIG. 3 the stopped price is 105). At the conclusion of the price improvement auction at step 318, all auction response messages, quotes, and interest on the non-volatile order book memory will be considered for execution against the price improvement order included in the received order message.

In certain example embodiments, for exchange 140 to initiate an auction, the order (e.g., the PRISM Order) that is transmitted in step 302 must be marked for Auction processing. The order may also specify: 1) a single price at which the order is to be executed (which may be called the “stop price” herein and a price at which the PRISM Order is guaranteed an execution by the Initiating Participant-client system X in FIG. 3); 2) that it is willing to automatically match as principal or as agent on behalf of an Initiating Order the price and size of all PAN (PRISM Auction Notifications) responses, and trading interest (“auto-match”) in which case the PRISM Order will be stopped at the NBBO on the Initiating Order side; or 3) that it is willing to either: (i) stop the entire order at a single stop price and auto-match PAN responses and trading interest at a price or prices that improve the stop price to a specified price NWT (a “No Worse Than”) price; (ii) stop the entire order at a single stop price and auto-match all PAN responses and trading interest at or better than the stop price; or (iii) stop the entire order at the NBBO on the Initiating Order side, and auto-match PAN responses and trading interest at a price or prices that improve the stop price up to the NWT price.

As used herein, an Initiating Participant is the participant that submitted the PRISM order to exchange 140. In FIG. 3, this is client X (the legal entity controlling client system X 109). Note, that the initiating participant may be different from the client that is ultimately associated with the PRISM order (as the Initiating Participant is acting on behalf of another entity). As used herein, the NWT price is a limiting price for the Auto-Match functionality described herein. In other words, the NWT is the price up to which the Initiating Participant is willing to Auto-Match PRISM Auction responses and orders (by using the Initiating Order).

In certain example embodiments, if the local BBO on the same side of the market as the PRISM order represents a limit order on the book, the stop price must be at least the minimum increment or better than the booked limit order's limit price. Once the PRISM Order is submitted for processing, it may not be modified or cancelled by the order submitting participant.

In connection with the above described circumstances (1)-(3) (the conditions under which a PRISM order may be submitted), the stop price or NWT price may be improved to the benefit of the PRISM Order during the auction process, but may not be cancelled. When starting an auction, the Initiating Participant may submit the Initiating Order with a designation of “surrender” to the other PRISM Participants, which will result in the Initiating Participant forfeiting the priority and trade allocation privileges which he is otherwise entitled. If Surrender is specified, the Initiating Order will only trade if there is not enough interest available to fully execute the PRISM Order at prices which are equal to or improve upon the stop price. In certain examples, the Initiating Participant will not receive an allocation percentage of more than 50% with one competing order or 40% with multiple competing orders. In certain examples, the Surrender process will not result in more than the maximum allowable allocation percentage to the Initiating Participant than that which the Initiating Participant would have otherwise received in accordance with the allocation procedures described herein.

In certain example embodiments, when a paired order of customer-to-customer origin is received, the order will execute immediately and not be subject to the example auction process described herein. In certain examples, exchange 140 will automatically allocate market makers but satisfaction occurs after public-customers.

As discussed in greater detail below, market makers (e.g., A and B in FIG. 3) that are present at the NBBO at the commencement of an auction at step 306 are known as “Priority Market Makers” and may be entitled for their corresponding auction response order to be satisfied up to the size that is displayed at the initial NBBO. In the example shown in FIG. 3, this includes participant A and B as they both have orders in the order book at the commencement of the auction at the NBBO. This will place them ahead (on a per price level basis) of other market makers if they submit price improving interest during the auction. The Priority Market Maker interest will be executed in a pro-rata fashion at each price point better than the initial NBBO, regardless of the allocation model of the underlying security. This advantageously may encourage competition and result in greater price improvement as well as a stronger NBBO presence on the exchange (e.g., such that the local BBO is usually the same as the NBBO). In other example embodiments, the Priority Market Maker interest may be allocated in a price/time fashion.

In certain examples, a Priority Market Maker is entitled to allocation priority ahead of other participants, except for Public Customers. In certain examples, at a given price point, which improves upon the “Initial NBBO” (the NBBO that existed when the PRISM order was accepted), Customer interest is allocated first, followed by Priority Market Maker interest in a pro-rata fashion, with all other interest then allocated based on the allocation model assigned to the underlying instrument. At each price point, a Priority Market Maker is entitled to priority status on volume which is equal to or less than the volume the Market Maker was displaying at the NBBO when the auction began. Any additional volume submitted by the Priority Market Maker is treated as non-priority Market Maker interest. When allocating at a price which equals the Initial NBBO, if the underlying security utilizes a Pro-Rata allocation model, the Priority Market Maker will continue to have priority ahead of other Market Makers and will be allocated in a Pro-Rata fashion among other Priority Market Makers; if the underlying security utilizes a Price Time allocation model, the allocation will be strictly Price Time.

### Auction Process

Returning to FIG. 3, the auction process begins at step 306 and continues during the time period of 307 until the auction ends at 318. In certain example embodiments, only one Auction may be conducted at a time in any given series (or may be performed on a per instrument or per symbol basis). In certain examples, once the auction is started, it is not stopped until complete.

In step 308, a PAN detailing the side and size of the PRISM Order will be transmitted to client systems 110A-110D (and perhaps client system X 109) as part of a market data feed. The PAN may be transmitted over a depth feed and/or a specialized quote feed that is used by the exchange to disseminate order book information to participants. While market data transmission 308 is shown in FIG. 3 as occurring after initialization of the auction at step 306, these two process may occur in reverse order or simultaneously.

The auction will last for a predetermined period of time 307. The auction length may be defined by the exchange 140 and be made publically available prior to initiation of the auction. In certain examples, the predetermined period of time will be no less than one hundred milliseconds and no more than one second (between 100 ms and 1 second).

When client systems 110A-110D (or other systems) respectively receive a PAN message, they may generate and submit responsive electronic data messages or PAN responses. The PAN responses may include a specified price, size, and side of the market. PAN responses are offers to match against the PRISM order.

In FIG. 3, client system D generates and submits, at step 310, PAN response for selling 50 at 104. Client systems A and B submit a sell orders, respectively in steps 314 and 312, for 50 at 104. In certain example embodiments, the 30 size for both A and B that is already present in the electronic order book of the exchange is automatically included in the “50” size submitted by A and B. In other words, A and B are looking to sell 50 at 104, 30 of which will be treated according to the Priority Market Maker techniques described herein. Finally, before the end of the auction process is triggered at step 318, client system 110C submits, at step 316, a message for a price of 103, a size of 10, and a side of sell.

It will be appreciated that due to the speed at which the auction process occurs, that the generation and submission of PAN responses are automatically controlled by suitable programmed computer systems associated with participants A-D (e.g., on or associated with client systems 110A, 110B, 110C, and 110D). In other words, the generation and submission of a given response, as a general matter, does not include manual input from a user or the like. Rather, the response is instead automatically handled according to each individually programmed computer system.

In certain example embodiments, PAN response messages that are generated and transmitted from client systems to the exchange 140, are not be visible to other participants and/or may not be disseminated to a reporting agency (e.g., such as the Options Price Reporting Authority or OPRA). For example, the message that is generated and transmitted in step 312 is not visible to client systems B, C, D, or X.

In certain example embodiments, the minimum price increment for PAN responses and for an Initiating Participant's stop price and/or NWT price shall be the minimum price improvement increment discussed above (e.g., 1 cent or the like).

In certain example embodiments, the size field that is included in a PAN response may not exceed the size of the PRISM Order. If the included size is greater than the size of the PRISM Order, then the exchange 140 will reject the order included in the PAN response.

In certain example embodiments, the price included in the PAN response must be equal to or better than the displayed NBBO at the time of receipt of the PAN response. In certain examples, a PAN response may be modified or cancelled while the auction process is underway. A PAN response submitted with a price that is outside the displayed NBBO will be rejected.

In certain example embodiments, any PAN responses on the same side of the market as the PRISM Order are considered invalid and will be rejected. In certain example embodiments, all PAN response will assumed to be on the opposite side of the PRISM order (e.g., the PAN response does not need to include a side value).

In certain example embodiments, multiple PAN responses from the same Participant (e.g., client system A) may be submitted during the Auction. Multiple orders at a particular price point submitted by a Participant in response to a PAN may not exceed, in the aggregate, the size of the PRISM Order.

In response to expiration of the timer that is being maintained by the exchange 140, the auction closes at step 318. In certain examples, the auction process may end if there is a trading halt on the exchange 140 in the affected series (e.g., the auction process may end based on the end of the auction period occurring or a trading halt occurring—whichever occurs first).

In certain examples, upon expiration of the auction process and if the local BBO has crossed the PRISM Order stop price on the same side of the market as the PRISM Order, the entire PRISM order will be executed at the best response price(s) or, if the stop price is the best price in the Auction, at the stop price, unless the best response price is equal to or better than the price of a limit order resting on the Order Book on the same side of the market as the PRISM Order, in which case the PRISM Order will be executed against that response, but at a price that is at the Minimum Increment better than the price of such limit order at the time of the conclusion of the Auction; otherwise execution would occur at the stop price.

In certain example embodiments, if there is a trading halt on exchange 140 the execution will be at the stop price, in which case the PRISM Order will be executed solely against the Initiating Order. Any unexecuted PAN responses will be cancelled.

In certain example embodiments, an unrelated market or marketable limit order (e.g., against the local BBO) on the opposite side of the market from the PRISM Order received during the auction will not cause the auction to end early and will execute against interest outside of the auction.

The following examples further illustrate the example auction processes that may be implemented on an example exchange computer system. These examples relate to how quantity from the PRISM order is allocated to contra-side orders.

### First Order Allocation Example Process

In certain examples, upon conclusion of the Auction, the PRISM Order will be allocated at the best price(s) as follows for underlying symbols which are designated as Size Pro-Rata. The priority for how orders are allocated may be based on the following elements:

First, Public Customer orders shall have time priority at each price level.

Second, the Initiating Participant shall be allocated after public customer orders according to the following three criteria: 1) If the Initiating Participant selected the single stop price option of the PRISM Auction, PRISM executions will occur at prices that improve the stop price, and then at the stop price with up to 40% of the remaining contracts after public customer interest is satisfied being allocated to the Initiating Participant at the stop price. However, if only one other participant matches the stop price, then the Initiating Participant may be allocated up to 50% of the contracts executed at such price. Remaining contracts shall be allocated, among remaining quotes, orders and PAN responses at the stop price. Thereafter, remaining contracts, if any, shall be allocated to the Initiating Participant. The allocation will account for Surrender, if applicable. 2) If the Initiating Participant selected the auto-match option of the PRISM Auction the Initiating Participant shall be allocated an equal number of contracts as the aggregate size of all other quotes, orders, and PAN responses at each price point until a price point is reached where the balance of the order can be fully executed, except that the Initiating Participant shall be entitled to receive up to 40% of the contracts remaining at the final price point (including situations where the stop price is the final price) after Customer interest has been satisfied but before remaining interest. Any remaining contracts shall be allocated to the Initiating Participant. 3) In the case of a PRISM, if the Initiating Participant selected the “stop and NWT” option of the PRISM Auction, contracts shall be allocated as follows: (i) first to quotes, orders, and PAN responses at prices better than the NWT price (if any), beginning with the best price, at each price point; (ii) next, to quotes, orders, and PAN responses at prices at the Initiating Participant's NWT price and better than the Initiating Participant's stop price, beginning with the NWT price. The Initiating Participant shall be allocated an equal number of contracts as the aggregate size of all other quotes, orders, and PAN responses at each price point, except that the Initiating Participant shall be entitled to receive up to 40% or 50% of the contracts remaining at the final price point (including situations where the final price is the stop price), after Customer interest has been satisfied but before remaining interest. In the case of an Initiating Order with a NWT price at the market, the Initiating Participant shall be allocated an equal number of contracts as the aggregate size of all other quotes, orders, and PAN responses at all price points, except that the Initiating Participant shall be entitled to receive up to 40% of the contracts remaining at the final price point (including situations where the final price is the stop price), after Customer interest has been satisfied but before remaining interest. Any remaining contracts shall be allocated to the Initiating Participant.

Third, local Market Makers that were at a price that is equal to or better than the displayed NBBO on the opposite side of the market from the PRISM Order at the time of initiation of the PRISM Auction (“Priority Market Makers”) shall have priority up to their quote size in the NBBO which was present when the PRISM Auction was initiated (“Displayed NBBO”) at each price level at or better than such Displayed NBBO after Public Customer and Initiating Participants have received allocations. Priority Market Maker quotes, orders, and PAN responses may be allocated pursuant to a Size Pro-Rata process.

Fourth, Non-Priority Market Makers and Priority Market Maker interest which exceeded the displayed size in the Initial Displayed NBBO shall have priority at each price level at or better than the Initial Displayed NBBO after public customer, Initiating Participants and Priority Market Makers have received allocations. Non-Priority Market Maker and Priority Market Maker interest which exceeded their displayed size in the Initial Displayed NBBO may be allocated pursuant to a Size Pro-Rata process.

Fifth, all other interest may be allocated pursuant to an example Size Pro-Rata process.

### Second Order Allocation Example Process

Alternatively, or in combination with, the first allocation process described above, a second allocation process may be used by using a Price/Time process. At the conclusion of the auction in step 318, the PRISM Order will be allocated at the best price(s) as indicated below for underlying symbols designated as Price/Time.

First, Public Customer orders shall have time priority at each price level.

Second, the Initiating Participant shall be allocated after public customer orders according to the following three criteria: 1) If the Initiating Participant selected the single stop price option of the PRISM Auction, PRISM executions will occur at prices that improve the stop price, and then at the stop price with up to 40% of the remaining contracts after public customer interest is satisfied being allocated to the Initiating Participant at the stop price. However, if only one other participant matches the stop price, then the Initiating Participant may be allocated up to 50% of the contracts executed at such price. Remaining contracts shall be allocated pursuant to an allocation process (e.g., pro-rata or price/time), among remaining quotes, orders and PAN responses at the stop price. Thereafter, remaining contracts, if any, shall be allocated to the Initiating Participant. The allocation will account for Surrender, if applicable. 2) If the Initiating Participant selected the auto-match option of the PRISM Auction the Initiating Participant shall be allocated an equal number of contracts as the aggregate size of all other quotes, orders and PAN responses at each price point until a price point is reached where the balance of the order can be fully executed, except that the Initiating Participant shall be entitled to receive up to 40% or 50% of the contracts remaining at the final price point (including situations where the stop price is the final price), after Customer interest has been satisfied but before remaining interest. If there are other quotes, orders, and/or PAN responses at the final price point the contracts will be allocated according to an example allocation process (e.g., price/time or pro-rata). Any remaining contracts shall be allocated to the Initiating Participant. 3) In the case of a PRISM, if the Initiating Participant selected the “stop and NWT” option of the PRISM Auction, contracts shall be allocated as follows: (i) first to quotes, orders, and PAN responses at prices better than the NWT price (if any), beginning with the best price, pursuant to an allocation process, at each price point; (ii) next, to quotes, orders and PAN responses at prices at the Initiating Participant's NWT price and better than the Initiating Participant's stop price, beginning with the NWT price. The Initiating Participant shall be allocated an equal number of contracts as the aggregate size of all other quotes, orders and PAN responses at each price point, except that the Initiating Participant shall be entitled to receive up to 40% of the contracts remaining at the final price point (including situations where the final price is the stop price), after Customer interest has been satisfied but before remaining interest. In the case of an Initiating Order with a NWT price at the market, the Initiating Participant shall be allocated an equal number of contracts as the aggregate size of all other quotes, orders and PAN responses at all price points, except that the Initiating Participant shall be entitled to receive up to 40% of the contracts remaining at the final price point (including situations where the final price is the stop price), after Customer interest has been satisfied but before remaining interest. If there are other quotes, orders and PAN responses at the final price point the contracts will be allocated according to an allocation process (e.g., price/time or pro-rata). Any remaining contracts shall be allocated to the Initiating Participant.

Third, Priority Market Makers that were at a price that is equal to or better than the displayed NBBO on the opposite side of the market from the PRISM Order at the time of initiation of PRISM Auction shall have priority up to their displayed quote size in the Initial Displayed NBBO at each price level better than the Initial Displayed NBBO, after public customer and Initiating Participants have received allocations. Priority Market Maker interest at prices better than the Initial Displayed NBBO will be allocated pursuant to an example Size Pro-Rata process. Priority Market Maker interest at a price equal to or inferior to the Initial Displayed NBBO will not have priority over other participants and will be allocated pursuant to the Price/Time process.

Fourth, all other interest will be allocated, pursuant to a Price/Time process.

### Allocation Example 1

Taking the example process shown in FIG. 3 (the PRISM order has a stop price of 105), at the conclusion of the automated auction process the following allocation may occur. Here, both A and B are classified (e.g., determined by the exchange) as Priority Market Makers. First, the size 10 order from C is traded (or matched) at 103, leaving 80 X remaining. Second, A and B both trade 30 at 104 since they have priority up to their size at the NBBO (they both had 30 displayed in the order book at the NBBO). After satisfaction of the priority size from A & B, the remaining 20 X is divided between the remaining interests of A (20), B (20), and D (50) on a pro-rata basis. This results in 4 to A, 4 to B, and 11 to D. The last remaining quantity (1) is allocated to D as D was first in time with the PAN response during the auction.

### Allocation Example 2

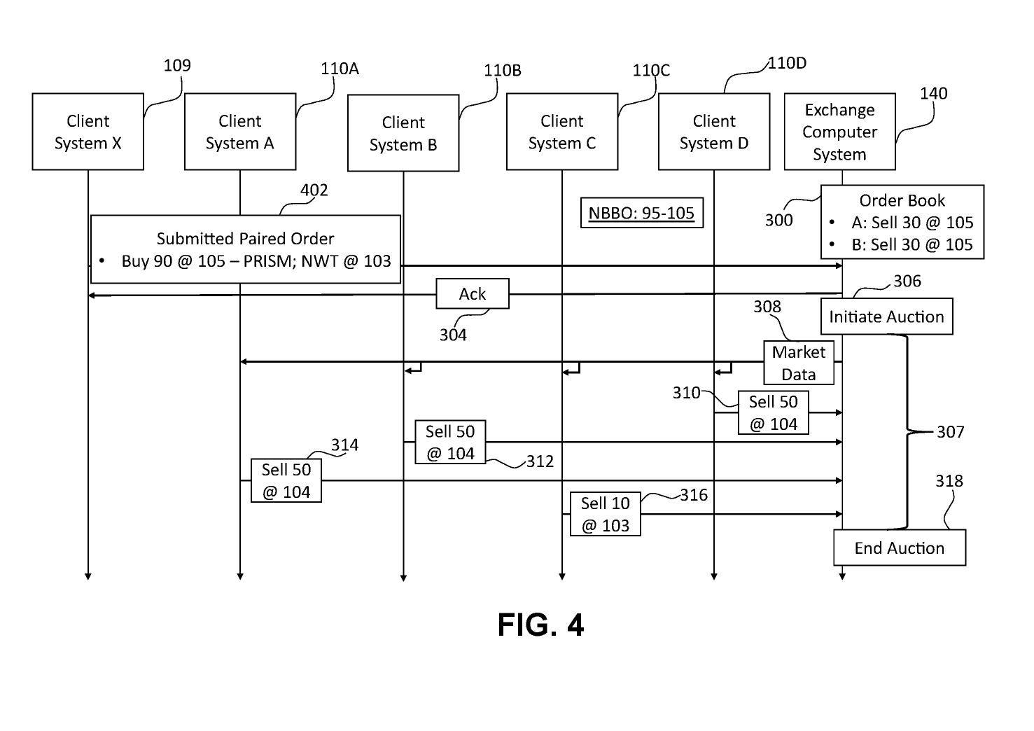

FIG. 4 shows an alternative example according to the auction process described herein. All of the steps are the same except the paired order submitted at step 402 includes a NWT value of 103. As with the above example shown for the situation in FIG. 3, both A and B classified as Priority Market Makers and the size 10 order from C is traded at 103, leaving 80 X remaining. However, in this case the PRISM contra order (the Initiating Order) also trades 10 @ 103. This leaves 70 of X. Further the PRISM contra order is allocated 40% of the remaining quantity (28) since 104 will be the final price point for the auction. This leave 42 remaining between A, B, and D. Both A and B are Priority Market Makers with 60 displayed size at the NBBO and accordingly the remaining 42 is split between A and B in a pro-rata fashion (21 each). D gets nothing.

### Allocation Example 3

Consider a modification to the above scenario where the PRISM order is 150 in size. In such an example, the PRISM contra order is allocated 40% of 130 (after 10 is allocated to C and the PRISM contra order at 103)−52. This leaves 78, of which A and B each take 30 each (up to their priority). Leaving 18. If the allocation for the underlying symbol is price/time (as detailed in the second order allocation example process below), then D will take the remaining 18. If the underlying symbol is pro-rata, it will be split among A, B, and D in a pro-rata fashion.

### Allocation Example 4

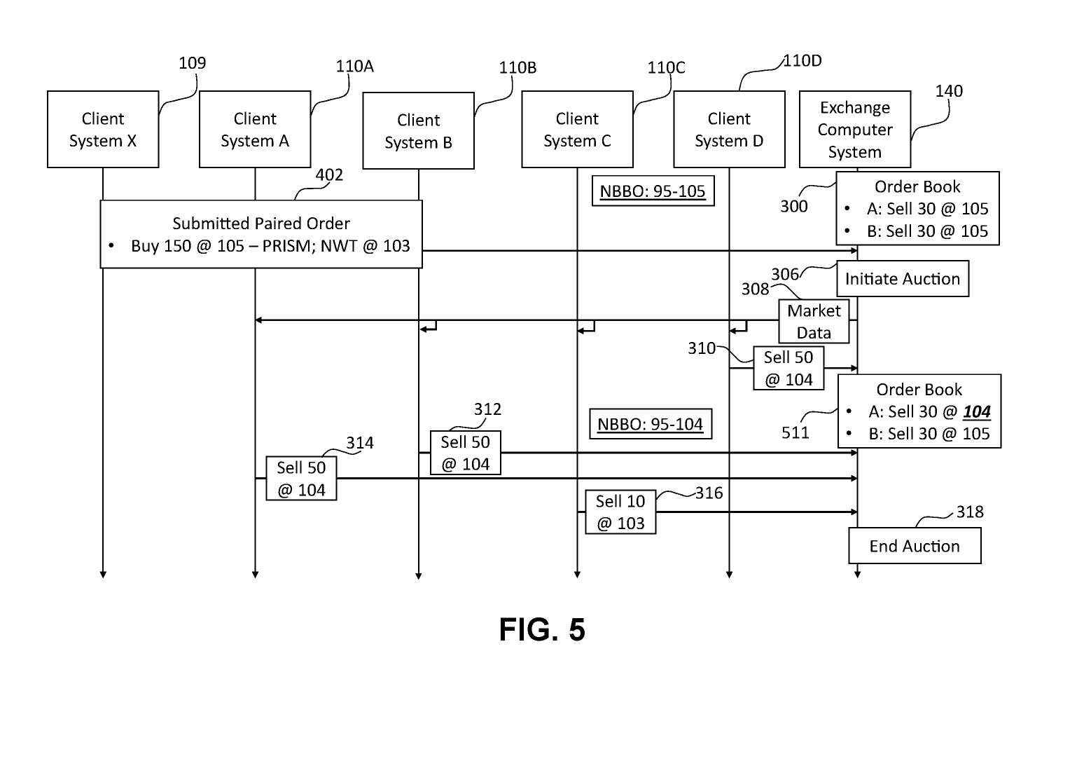

FIG. 5 shows an alternative example according to the auction process described herein. The example in FIG. 5 is similar to that shown in FIG. 4. However, in this example, the size of the PRISM order is 150 and during the auction process A moves his corresponding quote and thus the local (and NBBO) is moved at step 511 to 95-104.

When the auction ends, C and the PRISM contra trade 10 at 103. The PRISM contra order is allocated 40% of 130 (after 10 is allocated to C and the PRISM contra order at 103), or 52. This leaves 78. A and B each are matched/trade for 30 at 104 since they have priority up to their size at the NBBO when the auction started (since Market Maker A has both a response and quote interest, A's 30 is allocated in a time fashion among A's interest at 104 with each of the responses trading all 30 contracts). The residual 18 contracts are traded in a pro rata fashion among A, B, and D.

### Allocation Example 5

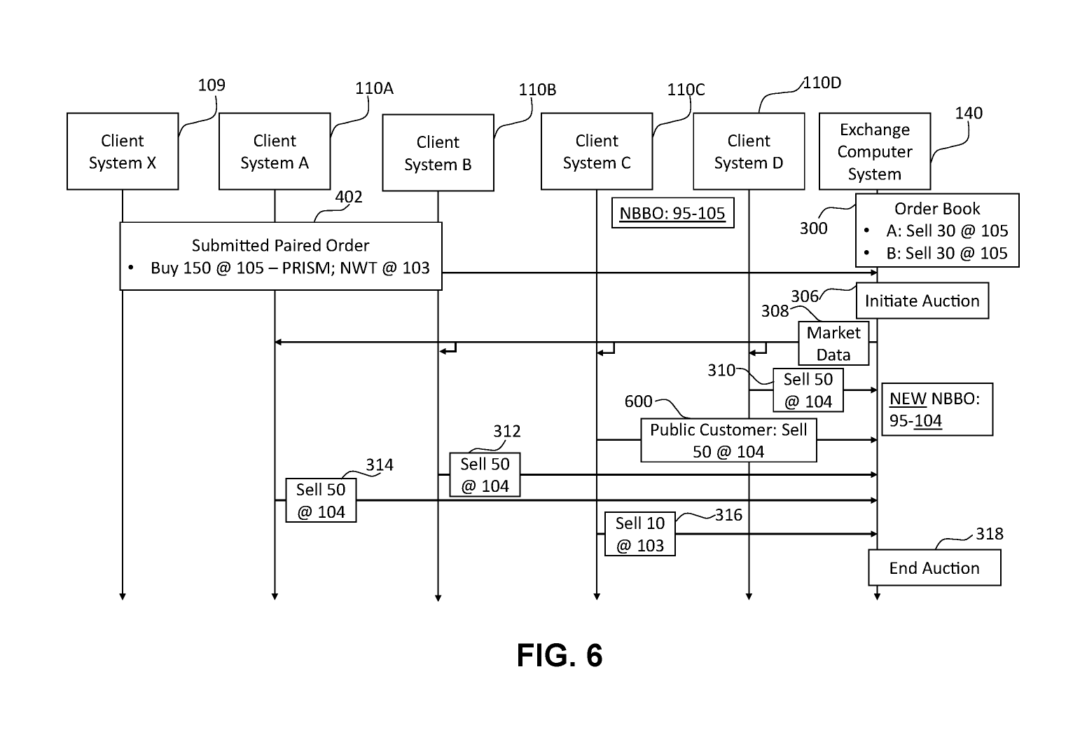

FIG. 6 shows an alternative example according to the auction process described herein. The example in FIG. 6 is similar to that shown in FIG. 5 (including the movement of the quote by A). However, in this example, a public customer submits an order at 104 (the new NBBO price) at step 600. As with the previous examples C and the PRISM contra order are allocated 10 each. The public customer then trades 50 at 104, leaving 90. PRISM contra is allocated 40%, or 36, leaving 54. The remaining 54 are divided pro-rata (or price/time) between A and B, leaving D with nothing.

### Allocation Example 6

In another example, a PRISM order of 300 at 103 (with an NBBO of 97-103) is received with a NWT of 101. A and B are offering 30 at 103. After commencement of the auction, C submits 5 and 101, A submits 10 at 102, B submits 50 at 102, D submits 40 at 102, A submits an additional 30 at 103. A also moves the quote during the auction to 102 with a “firm order” also offering 10 at 102. When the auction ends, C and the contra PRISM order are each allocated 5. The interest at price level 102 is allocated with A receiving 10, B receiving 30, and A quote trading at 102. B and D are allocated 20 and 40 respectively at 102. The firm order is allocated 10 at 102. The PRISM contra order is allocated the full volume being traded at 102 (for a total size of 120). The remaining 50 are traded at 103, with the PRISM contra taking 40% (20) and the other 30 being allocated pro rate (or price/time) between the 30 each of A and B.

### Allocation Example 7

In another example, A has an order for 30 in the order book at 105 (at the NBBO). A PRISM order for 50 is received with a stop price of 105. During the auction C submits 10 at 101. The auction ends. 10 of the 50 is allocated to Cat 101 and 50% of the remaining 40 (20) is allocated to the contra PRISM (as there is only one market marker at the stop price). A receives 20 at 105.

### Other Example Processes

In certain example embodiments, a single quote, order, or PAN response shall not be allocated a number of contracts that is greater than its size. Residual odd lots (e.g., if there is 1 to be divided among three contra orders) will be allocated in time-priority among interest with the highest priority. Rounding of the Initiating Participant will be up or down to the nearest integer, all other rounding is down to the nearest integer. If rounding would results in an allocation of less than one contract, then one contract will be allocated to the Initiating Participant only if the Initiating Participant did not otherwise receive an allocation.

In certain example embodiments, if there are PAN responses that cross the then-existing NBBO (provided such NBBO is not crossed), such PAN responses will be executed, if possible, at their limit price(s).

In certain example embodiments, if the price of the PRISM Auction Order is the same as that of an order on the limit order book on the same side of the market as the PRISM Order, the PRISM Order may only be executed at a price that is at least the Minimum Increment better than the resting order's limit price or, if such resting order's limit price is equal to or crosses the stop price, then the entire PRISM Order will trade at the stop price with all better priced interest being considered for execution at the stop price.

In certain example embodiments, any unexecuted PAN responses will be cancelled.

In certain example embodiments, if a PRISM Auction Order is initiated for an order designated as an Intermarket Sweep Order (ISO), all executions which are at a price inferior to the Initial Displayed NBBO shall be allocated pursuant to a Size Pro-Rata process.

In certain example embodiments, Post Only Orders will be executed if such order would not result in the removal of liquidity when executing in the PRISM Auction. A Post Only Order will be cancelled if it eligible for an execution in the PRISM Auction and would be considered the remover of liquidity.

In certain example embodiments, the exchange 140 may track submissions of PRISM orders and/or PAN responses. The exchange 140 (or the operator thereof) may determine, for each PRISM order, whether there is a genuine intention to execute a bona fide transaction. For example, it may be considered a violation and will be deemed conduct inconsistent with just and equitable principles of trade and a violation of Rule 2110 if an Initiating Participant submits a PRISM Order (initiating an Auction) and also submits its own PAN response in the same Auction the exchange may determine such actions and bar or flag the participant from taking further actions.

Other actions may also be classified as not being within the letter or spirit of execution of a bona find transaction. For example, the exchange may detect a pattern or practice of submitting multiple orders in response to a PAN at a particular price point that exceed, in the aggregate, the size of the PRISM Order. Such conduct may be deemed inconsistent with just and equitable principles of trade and a violation of Rule 2110.

In certain instances, a pattern or practice of submitting unrelated orders or quotes that cross the stop price, causing a PRISM Auction to conclude before the end of the PRISM Auction period will be deemed conduct inconsistent with just and equitable principles of trade and a violation of Rule 2110. It will also be deemed conduct inconsistent with just and equitable principles of trade and a violation of Rule 2110 to engage in a pattern of conduct where the Initiating Participant breaks up a PRISM Order into separate orders for the purpose of gaining a higher allocation percentage than the Initiating Participant would have otherwise received in accordance with the allocation procedures described herein.

In certain example embodiments, an Initiating Participant may enter a PRISM Order for the account of a Public Customer paired with an order for the account of a Public Customer and such paired orders will be automatically executed without a PRISM Auction. The execution price for such a PRISM Order must be expressed in the quoting increment applicable to the affected series. Such an execution may not trade through the NBBO or at the same price as any resting Public Customer order.

In certain example embodiments, auction notification messages (e.g., that are sent out as part of an electronic data feed) may be used. Such messages may be sent as part of step 308 where client systems 110 are notified of the start of the auction process. Also if any auction parameters change during the auction, size for example, a new Auction Notification message will be sent for that symbol.

This notification message is also used to inform of orders that are available for execution at the National Best Bid/Offer. Such notification is called “Order Exposure Alert” and is indicated by Auction Type value “I”. The delivery of this alert is optional and must be specifically requested. In below table, Table 1, is illustrated an example auction notification message.

TABLE 1

| Name | Offset | Length | Value | Notes |
|---|---|---|---|---|
| Message | 0 | 2 | Alpha | “NA” = Auction Notification |
| Type | | | | Message |
| Seconds | 2 | 4 | Integer | Seconds portion of timestamp |
| Nano- | 6 | 4 | Integer | Nanoseconds portion of |
| seconds | | | | timestamp |
| Option ID | 10 | 4 | Integer | Exchange option ID assigned |
| | | | | daily, valid for trading day |
| Security | 14 | 5 | Alpha | Industry assigned security symbol |
| Symbol | | | | for option contract |
| Expiration | 19 | 2 | Integer | Denotes the explicit expiration |
| (Y, M, D) | | | | date of the option: 1) Bits 0-6, |
| | | | | Year (0-99); 2) Bits 7-10 (1-12); |
| | | | | 3) Bits 11-15 (1-31); 4) bit 15 |
| | | | | least significant bit |
| Strike Price | 21 | 4 | Integer | Denotes the explicit strike price |
| | | | | of the option. Refer to Data |
| | | | | Types for field processing notes |
| Option | 25 | 1 | Alpha | Option Type: “C” = Call; “P” = |
| Type | | | | Pull |
| Auction ID | 26 | 4 | Integer | Uniquely identifies the auction |
| | | | | for the trading day |
| Auction | 30 | 1 | Alpha | Type of Auction: “O” = Opening |
| Type | | | | or Reopening; “P” = PIXL; |
| | | | | “S” = Solicitation; “I” = Order |
| | | | | exposure alert |
| Price | 31 | 4 | Integer | Price at which auction is started. |
| Side | 35 | 1 | Alpha | Indicates the side of the auction: |
| | | | | “B” = buy side; “S” = sell side; |
| | | | | “*” = Solicitation auction. |
| Matched | 36 | 4 | Integer | Indicates potential volume that |
| Volume | | | | can be trade at a price |
| Imbalance | 40 | 4 | Integer | Total number of contract better |
| Volume | | | | than Price (Includes orders that |
| | | | | cannot be filled) |
| Reserved | 44 | 4 | NA | Reversed for future use |

If the auction type is 0, then the price field is the potential opening price and the matched volume field is the volume at the auction price. If the auction type is P, the price field is price at auction start and volume field is the auction price. If the auction type is S, the price field is zero and the volume field is zero. If the auction type is I, then the price field is the price at which the exposed order is available and the matched volume field is zero.

In addition to above example auction notification message, there may exist a further message format for complex auction notifications. For example, when a Complex Order Live Auction or PRISM auction starts for a strategy of an underlying, a notification message containing the auction information will be sent. In below table, Table 2, is illustrated an example of such a Complex Auction Notification Message. The notification message in table 2 may be part of the market data transmitted in step 308.

TABLE 2

| Name | Offset | Length | Value | Notes |
|---|---|---|---|---|
| Message | 0 | 2 | Alpha | “NA” = Auction Notification |
| Type | | | | Message |
| Seconds | 2 | 4 | Integer | Seconds portion of timestamp |
| Nano- | 6 | 4 | Integer | Nanoseconds portion of |
| seconds | | | | timestamp |
| Strategy | 10 | 4 | Integer | Exchange Strategy ID assigned |
| ID | | | | daily, valid while there are any |
| | | | | open complex orders for the day |
| Auction | 14 | 4 | Integer | Uniquely identifies the auction |
| ID | | | | for the trading day |
| Auction | 18 | 1 | Alpha | Type of Auction: |
| Type | | | | “C” = COLA; “P” = PIXL; |
| | | | | “S” = Solicitation |
| Price | 19 | 4 | Integer | Price at which COLA/PIXL is |
| | | | | started. Set to zero for “S” |
| Side | 23 | 1 | Alpha | “B” = Buy side; “S” = Sell side; |
| | | | | “*” = Solicitation auctions |
| Debit Or | 24 | 1 | Alpha | Price is: “D” = Net Debit; “C” = |
| Credit | | | | Net Credit; “ ” = Even(or Market |
| | | | | Order); “*” = Anonymous (and |
| | | | | masked for solicitation auctions) |
| Volume | 25 | 4 | Integer | Total volume for COLA/PIXL |
| | | | | auction; 0 for solicitation auctions |

### Technical Advantages of Described Subject Matter

In certain example embodiments, the auction process described herein may facilitate more versatile matching between a submitted order (PRISM order) and others who are market participants. For example, an example PRISM auction may provide Market Makers who were present on the NBBO at the time the Auction was initiated to have allocation priority over Market Makers who were not on the Initial NBBO. This may correspondingly improve the presence of market makers (or other designated participants) on the NBBO.

### Selected Terminology

Whenever it is described in this document that a given item is present in “some embodiments,” “various embodiments,” “certain embodiments,” “certain example embodiments, “some example embodiments,” “an exemplary embodiment,” or whenever any other similar language is used, it should be understood that the given item is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments. Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an” and “the” should be read as meaning “at least one,” “one or more,” or the like; the term “example” is used provide examples of the subject under discussion, not an exhaustive or limiting list thereof; the terms “comprise” and “include” (and other conjugations and other variations thereof) specify the presence of the associated listed items but do not preclude the presence or addition of one or more other items; and if an item is described as “optional,” such description should not be understood to indicate that other items are also not optional.

As used herein, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage. The term “non-transitory computer-readable storage medium” does not include a transitory, propagating electromagnetic signal.

### Additional Applications of Described Subject Matter

Although process steps, algorithms or the like, including without limitation with reference to FIG. 6, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described preferred embodiment that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, component, or step in this specification is intended to be dedicated to the public.

1. An electronic exchange computer system comprising.
a memory configured to store a first and second list of electronic data order messages that are each associated with a symbol identifier, the first and second list, respectively, having a first plurality of electronic data order messages and a second plurality of electronic data order messages, each of the first and second plurality of electronic data order messages having at least a size value, a price value and being associated with a corresponding participant identifier and the symbol identifier;
a transceiver configured to receive electronic data order messages from other computing devices, the electronic data order messages including data messages that correspond, respectively, to each of the electronic order data messages of the first and second plurality;
a processing system that includes at least one processor coupled to the memory and the transceiver, the processing system configured to:
track a national best bid or offer (NBBO) for the symbol identifier;
receive, via the transceiver, a first electronic order data message that includes at least 1) a request to initiate an automated auction process for an auction order, 2) a first price value for the auction order, and 3) a first quantity value for the auction order, the auction order being contra to the first plurality of electronic data order messages and associated with an identifier of a participant who submitted the auction order;
based on reception of the first electronic order data message and determination of the request included therein, start the automated auction process for a predetermined period of time;
generate and then transmit, using the transceiver, auction notification messages to at least some of the other computing devices;
during the predetermined period of time, receive, via the transceiver, at least first and second electronic auction response messages that each include a corresponding price value and size value and that are associated with a corresponding participant identifier;
in response to expiration of the predetermined period of time, end the auction process;
determine whether any of the first and second electronic auction response messages are associated with a first participant identifier that is also associated with one of the first plurality of electronic data order messages that is determined to be at the NBBO at the time the auction process was initiated; and
as a result of determining that the first participant identifier is also associated with one of the first plurality of electronic data order messages that is at the NBBO, prioritize allocation of the auction order to a corresponding electronic auction response message that is associated with the first participant identifier.

2. The electronic exchange computer system of claim 1, wherein the prioritized allocation of the auction order to a corresponding electronic auction response message occurs for a size value that is no greater than the size value of the one of the first plurality of electronic data order messages that was at the NBBO at the time of the start of the auction.

3. The electronic exchange computer system of claim 1, wherein the first electronic order data message includes a paired order, which includes the auction order and another order that is contra to the paired order.

4. The electronic exchange computer system of claim 3, wherein the another order that is contra to the paired order is allocated, a per price level basis, up to a determined size against the auction order.

5. The electronic exchange computer system of claim 4, wherein the determined size is based on the total size of other contra-orders allocated to the auction order, on per-price level basis.

6. The electronic exchange computer system of claim 4, wherein the determined size is based on a predetermined percentage of the remaining size, the predetermined percentage being allocated in priority, on a price level basis, over the corresponding electronic auction response message that is associated with the first participant identifier.

7. The electronic exchange computer system of claim 1, wherein the first electronic order data message includes a no-worse-than value, wherein in response to determination that the corresponding price value of the corresponding electronic auction response message is equal to or worse the no-worse-than value, allocate up to the allocated size value for a given price level, quantity of the auction order to a contra-auction order that is associated with the participant who submitted the auction order.

8. The electronic exchange computer system of claim 1, wherein among multiple participant identifiers that are determined to be associated with orders of the first plurality of electronic data order messages that are at the NBBO at the start of the auction process, quantity for corresponding auction response messages is allocated pro-rata.

9. The electronic exchange computer system of claim 1, wherein after allocation of quantity according to determination of being at the NBBO, quantity of the electronic auction response messages is allocated according to price/time or pro-rata.

10. The electronic exchange computer system of claim 1, wherein during the auction process, an electronic order data message that is associated with a public customer is received, the electronic order data message that is associated with a public customer is allocated first, at each price level

11. The electronic exchange computer system of claim 1, wherein the size value of the corresponding electronic auction response message is greater than the size value of the one of the first plurality of electronic data order messages that is at the NBBO with the same first participant identifier,
wherein, the prioritized allocation of the corresponding electronic auction response message is handled only for the size value of the one of the first plurality of electronic data order messages that was at the NBBO with the same first participant identifier,
wherein a difference of the size value of corresponding electronic auction response message and the size value of the one of the first plurality of electronic data order messages that was at the NBBO with the same first participant identifier is allocated in price time or pro-rata fashion with other auction response messages at the same price level.

12. A method of matching electronically received data transaction requests by a computer system that includes electronic memory, a transceiver, and a processing system that includes at least one processor coupled to the electronic memory and the transceiver, the method comprising:
storing, in the electronic memory, a first and second list of electronic data order messages that are each associated with a symbol identifier, the first and second list, respectively, having a first plurality of electronic data order messages and a second plurality of electronic data order messages, each of the first and second plurality of electronic data order messages having at least a size value, a price value and being associated with a corresponding participant identifier and the symbol identifier;
receiving, via the transceiver, electronic data order messages from other computing devices, the electronic data order messages including data messages that correspond, respectively, to each of the electronic order data messages of the first and second plurality;
tracking a national best bid or offer (NBBO) for the symbol identifier;
receiving, via the transceiver, a first electronic order data message that includes at least 1) a request to initiate an automated auction process for an auction order, 2) a first price value for the auction order, and 3) a first quantity value for the auction order, the auction order being contra to the first plurality of electronic data order messages and associated with an identifier of a participant who submitted the auction order;
based on reception of the first electronic order data message and determination of the request included therein, starting the automated auction process for a predetermined period of time;
generating and then transmitting, using the transceiver, auction notification messages to at least some of the other computing devices;
during the predetermined period of time, receiving, via the transceiver, at least first and second electronic auction response messages that each include a corresponding price value and size value and that are associated with a corresponding participant identifier;
in response to expiration of the predetermined period of time, ending the auction process;
determining, whether any of the first and second electronic auction response messages are associated with a first participant identifier that is also associated with one of the first plurality of electronic data order messages that is determined to be at the NBBO at the time the auction process was initiated; and
as a result of determining that the first participant identifier is also associated with one of the first plurality of electronic data order messages that is at the NBBO, prioritizing allocation of the auction order to a corresponding electronic auction response message that is associated with the first participant identifier.

13. The method of claim 12, wherein the prioritized allocation of the auction order to a corresponding electronic auction response message occurs for a size value that is no greater than the size value of the one of the first plurality of electronic data order messages that was at the NBBO at the time of the start of the auction.

14. The method of claim 12, wherein the first electronic order data message includes a paired order, which includes the auction order and another order that is contra to the paired order.

15. The method of claim 14, wherein the another order that is contra to the paired order is allocated, a per price level basis, up to a determined size against the auction order.

16. The method of claim 12, wherein the first electronic order data message includes a no-worse-than value, wherein in response to determination that the corresponding price value of the corresponding electronic auction response message is equal to or worse the no-worse-than value, allocate up to the allocated size value for a given price level, quantity of the auction order to a contra-auction order that is associated with the participant who submitted the auction order.

17. The method of claim 12, wherein among multiple participant identifiers that are determined to be associated with orders of the first plurality of electronic data order messages that are at the NBBO at the start of the auction process, quantity for corresponding auction response messages is allocated pro-rata.

18. The method of claim 12, wherein the size value of the corresponding electronic auction response message is greater than the size value of the one of the first plurality of electronic data order messages that is at the NBBO with the same first participant identifier,
wherein, the prioritized allocation of the corresponding electronic auction response message is handled only for the size value of the one of the first plurality of electronic data order messages that was at the NBBO with the same first participant identifier,
wherein a difference of the size value of corresponding electronic auction response message and the size value of the one of the first plurality of electronic data order messages that was at the NBBO with the same first participant identifier is allocated in price time or pro-rata fashion with other auction response messages at the same price level.

19. A non-transitory computer readable storage medium having stored thereon computer readable instructions for use with a computer system that includes at least one processor, electronic memory, and a transceiver, the electronic memory configured to store a first and second list of electronic data order messages that are each associated with a symbol identifier, the first and second list, respectively, having a first plurality of electronic data order messages and a second plurality of electronic data order messages, each of the first and second plurality of electronic data order messages having at least a size value, a price value and being associated with a corresponding participant identifier and the symbol identifier, the stored computer readable instructions comprising instructions that cause the computer system to
obtain a national best bid or offer (NBBO) for the symbol identifier;
receive, via the transceiver, a first electronic order data message that includes at least 1) a request to initiate an automated auction process for an auction order, 2) a first price value for the auction order, and 3) a first quantity value for the auction order, the auction order being contra to the first plurality of electronic data order messages and associated with an identifier of a participant who submitted the auction order;
based on reception of the first electronic order data message and determination of the request included therein, start the automated auction process for a predetermined period of time;
generate and then transmit, using the transceiver, auction notification messages to at least some of the other computing devices;
during the predetermined period of time, receive, via the transceiver, at least first and second electronic auction response messages that each include a corresponding price value and size value and that are associated with a corresponding participant identifier;
in response to expiration of the predetermined period of time, end the auction process;
determine, whether any of the first and second electronic auction response messages are associated with a first participant identifier that is also associated with one of the first plurality of electronic data order messages that is determined to be at the NBBO at the time the auction process was initiated; and
as a result of determining that the first participant identifier is also associated with one of the first plurality of electronic data order messages that is at the NBBO, prioritize allocation of the auction order to a corresponding electronic auction response message that is associated with the first participant identifier.

20. The non-transitory computer readable storage medium of claim 19, wherein the prioritized allocation of the auction order to a corresponding electronic auction response message occurs for a size value that is no greater than the size value of the one of the first plurality of electronic data order messages that was at the NBBO at the time of the start of the auction.
